(19) United States
(12) Patent Application Publication
(10) Pub. No.: US 2021/0021749 A1
(43) Pub. Date: Jan. 21, 2021

(54) IMAGING SYSTEM, WIRELESS COMMUNICATION MODULE, AND HANDHELD GIMBAL

(71) Applicant: SZ DJI TECHNOLOGY CO., LTD., Shenzhen (CN)

(72) Inventors: Dong LI, Shenzhen (CN); Yuqun CAI, Shenzhen (CN)

(21) Appl. No.: 17/060,991

(22) Filed: Oct. 1, 2020

Related U.S. Application Data
(63) Continuation of application No. PCT/CN2018/110799, filed on Oct. 18, 2018.

(51) Int. Cl. H04N 5/232; F16M 13/04; H01Q 1/24; H01Q 1/22; H04W 4/80

(52) U.S. Cl. CPC H04N 5/232; F16M 13/04; H04W 4/80; H01Q 1/2291; H01Q 1/243

(57) ABSTRACT

The present disclosure provides an imaging system. The imaging system includes an imaging host. The imaging host includes a camera and a host interface connected with the camera. The imaging system includes a wireless communication module. The wireless communication module includes a circuit board, a Bluetooth antenna, and a Wi-Fi antenna, the Bluetooth antenna and Wi-Fi antenna being disposed on the circuit board, and the wireless communication module and the host interface being plugged into the imaging host.

### CROSS-REFERENCE TO RELATED APPLICATION

This application is a continuation of International Application No. PCT/CN2018/110799, filed on Oct. 18, 2018, the entire content of which is incorporated herein by reference.

### TECHNICAL FIELD

The present disclosure relates to the field of imaging and, more specifically, to an imaging system, a wireless communication module, and a handheld gimbal.

### BACKGROUND

An imaging system can be used for photographing, video recording, etc., and is widely used in many fields. The imaging system can be equipped with a plurality of antennas to communicate with wireless devices, such as mobile phones and wireless routers. However, the plurality of antennas of the conventional imaging system are disposed separately, which occupies a large space. Therefore, the imaging system is not highly integrated and the structure is not compact.

### SUMMARY

One aspect of the present disclosure provides an imaging system. The imaging system includes an imaging host. The imaging host includes a camera and a host interface connected with the camera. The imaging system includes a wireless communication module. The wireless communication module includes a circuit board, a Bluetooth antenna, and a Wi-Fi antenna, the Bluetooth antenna and Wi-Fi antenna being disposed on the circuit board, and the wireless communication module and the host interface being plugged into the imaging host.

Another aspect of the present disclosure provides a wireless communication module. The wireless communication module includes a circuit board. A Bluetooth antenna is disposed on the circuit board. A Wi-Fi antenna is disposed on the circuit board. A Bluetooth-Wi-Fi chip is disposed on the circuit board, and connected with the Bluetooth antenna and the Wi-Fi antenna. A module interface is disposed on the circuit board and electrically connected to the Bluetooth-Wi-Fi chip for plugging into an imaging host of an imaging system and connecting the wireless communication module with the imaging host.

Another aspect of the present disclosure provides a handheld gimbal. The handheld gimbal includes a handle and an imaging host including a gimbal mounted on the handle, a camera disposed on the gimbal, and a host interface connected with the camera. The handheld gimbal further includes a wireless communication module including a circuit board, a Bluetooth antenna, and a Wi-Fi antenna. The Bluetooth antenna and Wi-Fi antenna are disposed on the circuit board, and the wireless communication module and the host interface are plugged into the imaging host.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic diagram of an imaging system according to an embodiment of the present disclosure.

FIG. 2 is a circuit board layout diagram of a wireless communication module of the imaging system shown in FIG. 1.

FIG. 3 is a side view of the circuit board of the wireless communication module shown in FIG. 2.

FIG. 4 is a diagram of the layout of the back of the circuit board of the wireless communication module shown in FIG. 2.

FIG. 5 is a return loss diagram of a Bluetooth antenna shown in FIG. 2.

FIG. 6 is a return loss diagram of a Wi-Fi antenna shown in FIG. 2.

FIG. 7 is a return loss diagram of the Bluetooth antenna and the Wi-Fi antenna shown in FIG. 2.

FIG. 8 is a three-dimensional (3D) schematic diagram of a handheld gimbal according to an embodiment of the present disclosure.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Illustrative embodiments will be described in detail. Such illustrations are shown in the accompanying drawings. When the following descriptions refer to a drawing, unless otherwise noted, the same numbers used in different drawings refer to the same or similar elements. The implementations described in the following illustrative embodiments do not represent all the implementations consistent with the present disclosure. Instead, they are only examples of devices and methods that are consistent with some aspects of the present disclosure described in the claims.

As described herein, the terms used in the specification of the present disclosure are intended to describe example embodiments, instead of limiting the present disclosure. In addition, the singular forms “a,” “an,” and “the” are intended to include the plural forms as well, unless the context indicates otherwise. It should be also understood that the term “and/or” as used herein refers to and encompasses any and all possible combinations of one or more of the related items listed.

It is to be understood that phraseology and terminology used herein with reference to device or element orientation (such as, terms like “center”, “longitudinal”, “lateral”, “length”, “width”, “height”, “up”, “down”, “front”, “rear”, “left”, “right”, “vertical”, “horizontal”, “top”, “bottom”, “inside”, “outside”, “clockwise”, “anticlockwise”, “axial”, “radial”, “circumferential”) are only used to simplify description of the present invention, and do not indicate or imply that the device or element referred to must have or operated in a particular orientation. They cannot be seen as limits to the present disclosure.

In the present disclosure, unless specified or limited otherwise, the terms “mounted,” “connected,” “coupled,” “fixed” and the like are used broadly, and may be, for example, fixed connections, detachable connections, or integral connections; may also be mechanical or electrical connections; may also be direct connections or indirect connections via intervening structures; may also be inner communications of two elements or interactions of two elements, which can be understood by those skilled in the art according to specific situations.

An embodiment of the present disclosure provides an imaging system. The imaging system may include an imaging host and a wireless communication module. The imaging host may include a camera and a host interface connected with the camera. The wireless communication module may include a circuit board, a Bluetooth antenna, a Wi-Fi antenna, a Bluetooth-Wi-Fi chip connected with the Bluetooth antenna and the Wi-Fi antenna, and a module interface electrically connected with the Bluetooth-Wi-Fi chip. The Bluetooth antenna, Wi-Fi antenna, Bluetooth-Wi-Fi chip, and module interface may be disposed on the circuit board. The wireless communication module may be assembled on the imaging host by connecting the module interface and the host interface.

The Bluetooth antenna and the Wi-Fi antenna of the wireless communication module of the imaging system may be both connected to the Bluetooth-Wi-Fi chip. The Bluetooth-Wi-Fi chip can support Bluetooth and Wi-Fi, such that Bluetooth and Wi-Fi can be combined. As such, the wireless communication module of the imaging system can be highly integrated and compact. In addition, the wireless communication module may be plugged into the imaging host through the module interface and the host interface of the imaging host. Therefore, the imaging host can have a compact structure and small size, which can reduce or avoid the impact of metal parts, such as the camera of the imaging host, on the antenna.

An embodiment of the present disclosure provides a wireless communication module. The wireless communication module may be used for wireless communication of the imaging system. The wireless communication module may include a circuit board, a Bluetooth antenna, a Wi-Fi antenna, a Bluetooth-Wi-Fi chip, and a module interface. The Bluetooth antenna may be disposed on the circuit board. The Wi-Fi antenna may be disposed on the circuit board. The Bluetooth-Wi-Fi chip may be disposed on the circuit board and connected with the Bluetooth antenna and the Wi-Fi antenna. The module interface may be disposed on the circuit board and electrically connected to the Bluetooth-Wi-Fi chip. The module interface may be used to plug into the imaging host of the imaging system to connect the wireless communication module with the imaging host.

An embodiment of the present disclosure provides a handheld gimbal. The handheld gimbal may include a handle, an imaging host, and a wireless communication module. The imaging host may include a gimbal assembled on the handle, a camera disposed on the gimbal, and a host interface connected with the camera. The wireless communication module may include a circuit board, a Bluetooth antenna, a Wi-Fi antenna, a Bluetooth-Wi-Fi chip connected with the Bluetooth antenna and the Wi-Fi antenna, and a module interface electrically connected with the Bluetooth-Wi-Fi chip. The Bluetooth antenna, Wi-Fi antenna, Bluetooth-Wi-Fi chip, and module interface may be disposed on the circuit board. The wireless communication module may be assembled on the imaging host by connecting the module interface and the host interface.

The imaging system, wireless communication module, and handheld gimbal of the present disclosure will be described in detail below with reference to the accompanying drawings. In the case where there is no conflict between the exemplary embodiments, the features of the following embodiments and examples may be combined with each other.

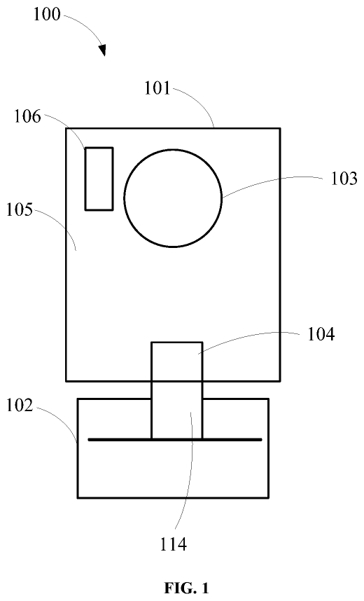

FIG. 1 is a schematic diagram of an imaging system 100 according to an embodiment of the present disclosure. The imaging system 100 includes an imaging host 101 and a wireless communication module 102. The imaging host 101 can be used to capture images and videos. The wireless communication module 102 may be connected with the imaging host 101 to realize wireless communication between the imaging host 101 and wireless devices such as mobile phones, tablets, and wireless routers.

The imaging host 101 may include a camera 103 and a host interface 104. In some embodiments, the camera 103 may include a lens, an image sensor, and an image processor. The lens may include multiple lens. The image sensor, such as CMOS or CCD, can convert the light passing through the lens into electrical signals. The image processor can process electrical signals to obtain images or videos. In some embodiments, the camera 103 may be a digital camera, which may include an A/D converter, which converts the electrical signal converted by the image processor into a digital signal, which can be processed by the image processor. The image or video obtained by the image processor processing can be sent to the host interface 104.

In some embodiments, the imaging system 100 may include a handheld gimbal. The imaging host 101 of the handheld gimbal may include a gimbal 105, and the camera 103 may be mounted on the gimbal 105. In other embodiments, the imaging system 100 may include a handheld camera, and the camera 103 may be a camera of the handheld camera. In other embodiments, a battery 106 may be disposed in the imaging host 101 for powering the imaging host 101. The imaging host 101 may work independently.

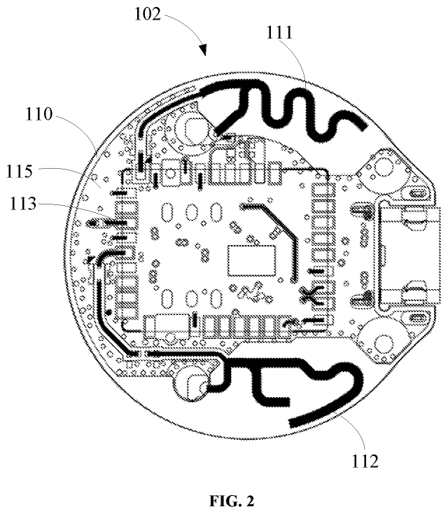

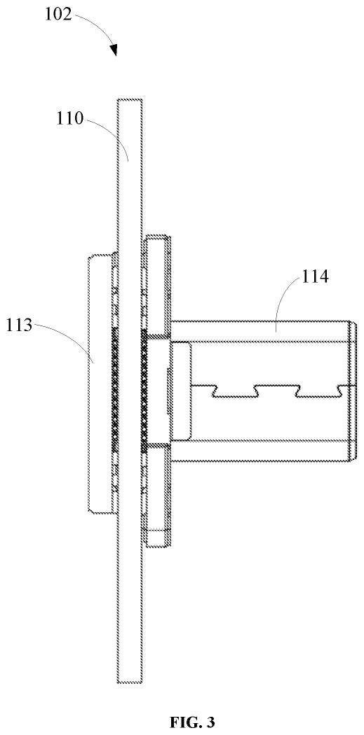

FIG. 2 is a circuit board layout diagram of the wireless communication module 102 according to an embodiment of the present disclosure, and FIG. 3 is a side view of the wireless communication module 102. The wireless communication module 102 includes a circuit board 110, a Bluetooth antenna 111, a Wi-Fi antenna 112, a Bluetooth-Wi-Fi chip 113 connected to the Bluetooth antenna 111 and the Wi-Fi antenna 112, and a module interface 114 electrically connected to the Bluetooth-Wi-Fi chip 113. The Bluetooth antenna 111, Wi-Fi antenna 112, Bluetooth-Wi-Fi chip 113, and module interface 114 may be disposed on the circuit board 110. The wireless communication module 102 may be assembled on the imaging host 101 by plugging in the module interface 114 and the host interface 104.

Both the Bluetooth antenna 111 and the Wi-Fi antenna 112 may be connected to the Bluetooth-Wi-Fi chip 113. The Bluetooth-Wi-Fi chip 113 can support Bluetooth and Wi-Fi, such that Bluetooth and Wi-Fi can be combined. As such, the wireless communication module 102 of the imaging system 100 can be highly integrated and compact.

In addition, some conventional wireless communication modules are disposed in the imaging host, such that the imaging host becomes bulky and not compact in structure. Moreover, due to the limited space in of the imaging host, the wireless communication module may be placed close to the metal parts, such as the camera, in the imaging host, and the antenna performance of the wireless communication module can be easily affected by the metal parts, such as the camera. Alternatively, in some conventional imaging systems, in order to reduce the impact of metal parts on the performance of the antenna, the wireless communication module 102 may be placed in the imaging host, but far away from the metal parts, such as the camera. However, this will result in a large size of the imaging host, which is not convenient for the miniaturization of the imaging system.

The wireless communication module 102 of the embodiment of the present disclosure can be plugged into the imaging host 101 through the module interface 114 and the host interface 104 of the imaging host 101. The wireless communication module 102 can be disposed outside the imaging host 101, such that the structure of the imaging host 101 is compact and size is small. In addition, the wireless communication module 102 can be far away from the metal parts, such as the camera 103, which can recue or avoid the influence of the metal parts, such as the camera 103 of the imaging host 101 on the antenna performance. Further, the wireless communication module 102 can be plugged into or unplugged from the imaging host 101 through the module interface 114, which is flexible to use. The imaging host 101 can work independently without wireless connection, or it can also connect to the wireless communication module 102 to communicate with wireless devices.

In some embodiments, the circuit board 110 may be a printed circuit board (PCB), and the Bluetooth antenna 111 and the Wi-Fi antenna 112 may be printed on the PCB board. In some embodiments, the Bluetooth antenna 111 and the Wi-Fi antenna 112 may be positioned on opposite sides of the Bluetooth-Wi-Fi chip 113, such that the isolation between the Bluetooth antenna 111 and the Wi-Fi antenna 112 can be improved better, and the mutual interference during work can be reduced. The Bluetooth-Wi-Fi chip 113 may be disposed in the middle of the circuit board 110, and the Bluetooth antenna 111 and the Wi-Fi antenna 112 may be disposed respectively close to the sides of the circuit board 110. In one example, the Bluetooth-Wi-Fi chip 113 may occupy an area of 15×22 mm on the circuit board 110. As such, one chip can support two antennas at the same time, and the space occupied is limited, such that the circuit board 110 can be smaller, and the wireless communication module 102 can have a compact structure and small size.

In some embodiments, the Bluetooth antenna 111 may be bent and extended, such that the length of the Bluetooth antenna 111 can be ensured and the space occupied by the circuit board 110 can be relatively small, for example, the area of the circuit board 110 may be approximately 5×15 mm. In some embodiments, the Wi-Fi antenna 112 may be bent and extended, such that the length of the Bluetooth antenna 111 can be ensured and the space occupied by the circuit board 110 can be relatively small. In some embodiments, the Wi-Fi antenna 112 may include a dual-frequency antenna or a multi-frequency antenna, and may work in two or more than three frequency bands. In some embodiments, the Wi-Fi antenna 112 may include an AFE antenna, which may be suitable for a small and compact wireless communication module.

In some embodiments, a ground plate 115 may be disposed on the circuit board 110 between the Bluetooth antenna 111 and the Wi-Fi antenna 112, which can better isolate the Bluetooth antenna 111 and the Wi-Fi antenna 112. The ground plate 115 can be grounded, and the Bluetooth antenna 111 and the Wi-Fi antenna 112 may extend outside the ground plate 115. In some embodiments, the ground plate 115 may be disposed on the surface of the circuit board 110 to facilitate testing. In other embodiments, the circuit board 110 may include a multilayer circuit board, and the ground plate 115 may be disposed on the middle layer of the multilayer circuit board to prevent static.

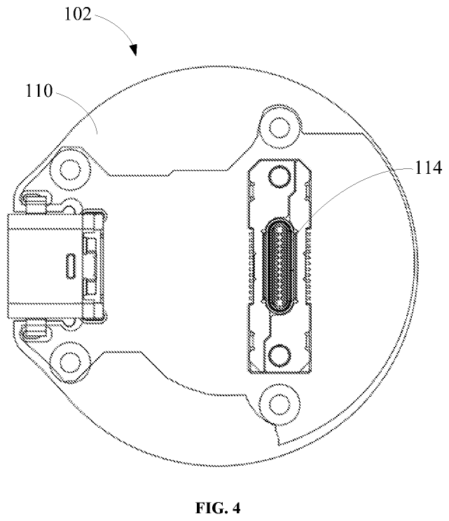

FIG. 4 is a schematic diagram of the back of the circuit board 110 of the wireless communication module 102. Referring to FIGS. 2 to 4, in some embodiments, the Bluetooth antenna 111, Wi-Fi antenna 112, and Bluetooth-Wi-Fi chip 113 may be disposed on the front of the circuit board 110, and the module interface 114 may be disposed on the back of the circuit board 110. As such, the space of the circuit board 110 can be fully utilized. The module interface 114 may be mounted substantially perpendicular to the surface of the circuit board 110. In some embodiments, the module interface 114 may include a type-C interface, a USB interface, or a serial port, and the host interface 104 (as shown in FIG. 1) that can be plugged into the module interface 114 may be a corresponding interface.

Further, referring to FIGS. 1 and 2, the camera 103 of the imaging host 101 may be electrically connected to the Bluetooth-Wi-Fi chip 113 through the host interface 104 and the module interface 114 to transmit signals. The Bluetooth-Wi-Fi chip 113 can wireless communicate with the wireless device through the Bluetooth antenna 111 and the Wi-Fi antenna 112. The Bluetooth antenna 111 and the Wi-Fi antenna 112 can receive electromagnetic signals sent by the wireless device, and the Bluetooth-Wi-Fi chip 113 can convert the electromagnetic signals received by the Bluetooth antenna 111 and the Wi-Fi antenna 112 into electrical signals, and send them to the imaging host 101. The electrical signals from the camera 103 of the imaging host 101 can be sent to the Bluetooth-Wi-Fi chip 113 through the host interface 104 and the module interface 114. The Bluetooth-Wi-Fi chip 113 can excite the Bluetooth antenna 111 and the Wi-Fi antenna 112 to emit corresponding electromagnetic waves, and the wireless device can receive the electromagnetic waves, thereby realizing the communication between the imaging host 101 and the wireless device.

In some embodiments, the Bluetooth antenna 111 and the Wi-Fi antenna 112 can work in cooperation and send different signals. In some embodiments, the Bluetooth antenna 111 can receive the uplink transmission signal sent by the wireless device, and the Wi-Fi antenna 112 can send the downlink transmission signal to the wireless device.

In some embodiments, the Bluetooth antenna 111 may be used to receive a Wi-Fi password. The wireless device may wirelessly communicate with the wireless communication module 102 through the Bluetooth antenna 111, the wireless device may send the Wi-Fi password to the wireless communication module 102, and the Bluetooth-Wi-Fi chip 113 may receive the Wi-Fi password through the Bluetooth antenna 111. After the Bluetooth-Wi-Fi chip 113 receives the Wi-Fi password, it can communicate with the wireless device through Wi-Fi. Using Bluetooth to share Wi-Fi password can speed up the Wi-Fi connection.

In some embodiments, the Bluetooth antenna 111 may be used to receive a control instruction for controlling the imaging host 101. The wireless device may send a control instruction to control the imaging host 101, and may transmit the control instruction through Bluetooth to remotely control the imaging host 101. Since the data size of the control instruction is relatively small, the Bluetooth antenna 111 can quickly receive the control instruction. In some embodiments, the control instruction may include a gimbal instruction for controlling the movement of the gimbal 105 and/or an imaging control instruction for controlling the camera 103 to shoot. The orientation, rotation direction, and angle of the 105 can be controlled. The camera 103 can be controlled to start shooting, stop shooting, pause shooting, etc. The Bluetooth antenna 111 may be used to receive an imaging parameter setting signal. The imaging parameter may include the shooting mode, aperture, exposure time, focal length, ISO, etc.

In some embodiments, the Wi-Fi antenna 112 may be used to transmit images and/or videos captured by the camera 103. Since the bandwidth of the Wi-Fi antenna 112 is relatively large, images and videos can be transmitted quickly. The image and/or video captured by the camera 103 can be sent to the wireless device through the Wi-Fi antenna 112. The captured image and video can also be transmitted in real time during shooting.

In other embodiments, the Wi-Fi antenna 112 may be used to receive uplink signals sent by the wireless device. In some embodiments, the Wi-Fi antenna 112 may be used to receive a control instruction for controlling the imaging host 101. The control instruction may include a control instruction for controlling the movement of the gimbal 105 or an imaging control instruction for controlling the camera 103 to shoot. The Wi-Fi antenna 112 may be used to receive the imaging parameter setting signal. The Wi-Fi antenna 112 may replace the Bluetooth antenna 111 to receive the control instruction, thereby remotely controlling the imaging host 101 through Wi-Fi. In one example, the remote control distance may reach more than 10 m, and the remote control distance is relatively long. The above are merely some examples, in some embodiments, the Bluetooth antenna 111 and the Wi-Fi antenna 112 can also transmit other signals.

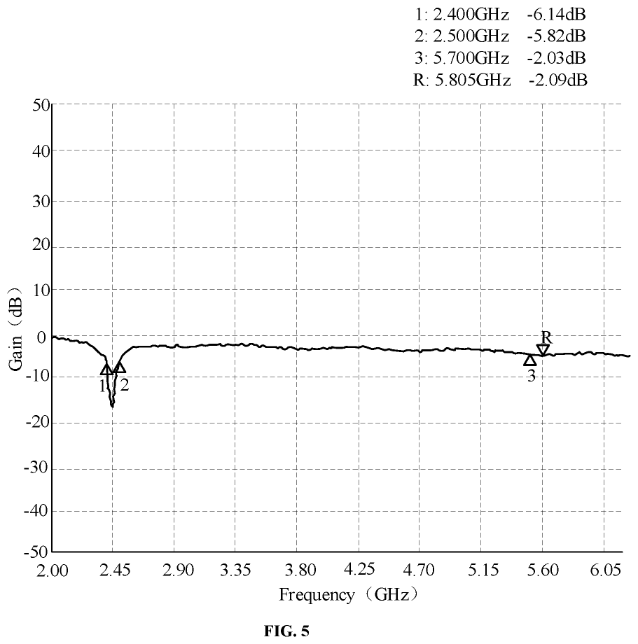

FIG. 5 is a return loss graph of the Bluetooth antenna 111. As shown in FIG. 5, the resonance frequency of the Bluetooth antenna 111 covers 2.4 GHz to 2.48 GHz, which can cover the frequency band of Bluetooth, indicating that the wireless communication module 102 can perform Bluetooth communication.

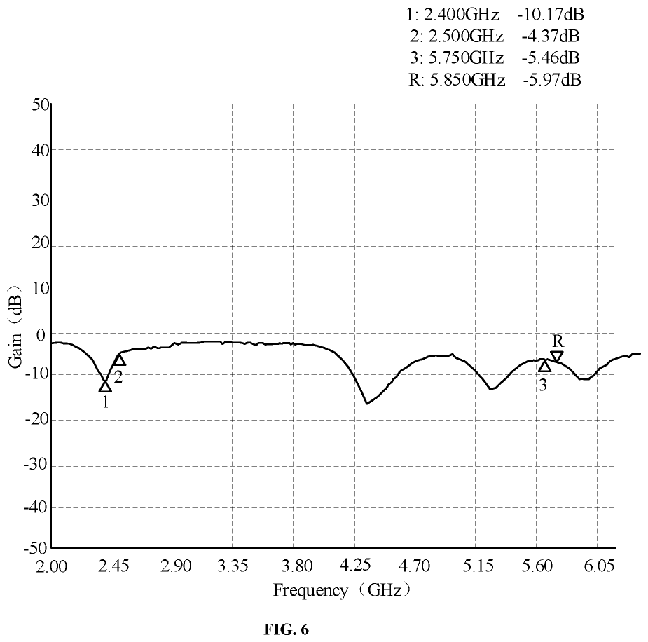

FIG. 6 is a return loss graph of the Wi-Fi antenna 112. As shown in FIG. 6, the Wi-Fi antenna 112 has a resonance at 2.4 GHz to 2.5 GHz and 5.15 GHz to 5.85 GHz, covering the 2.4 G and 5G frequency bands of Wi-Fi. In this embodiment, the Wi-Fi antenna 112 is a dual-band antenna, the frequency bands are 2.4G and 5G respectively, and the wireless communication module 102 can perform dual-band Wi-Fi communication.

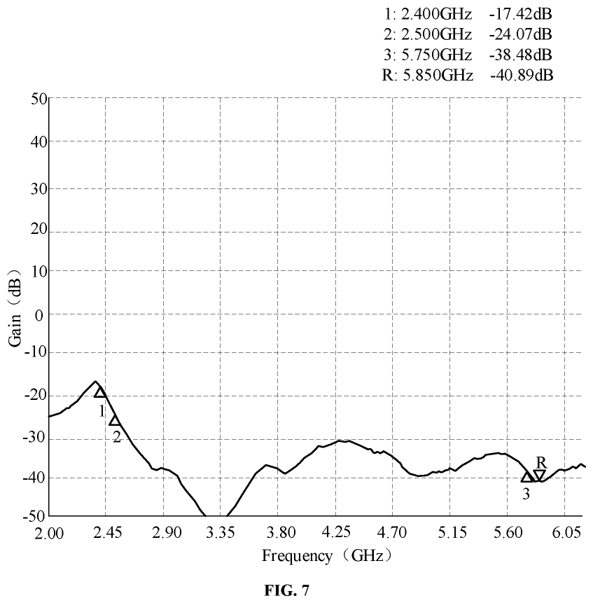

FIG. 7 is a return loss graph of the Wi-Fi antenna 112 and the Bluetooth antenna 111. As shown in FIG. 7, that isolation in the 2.4 GHz to 2.5 GHz and 5.15 GHz to 5.85 GHz frequency bands is greater than 17 dB, indicating that the isolation between the Wi-Fi antenna 112 and the Bluetooth antenna 111 is high and the mutual interference is low.

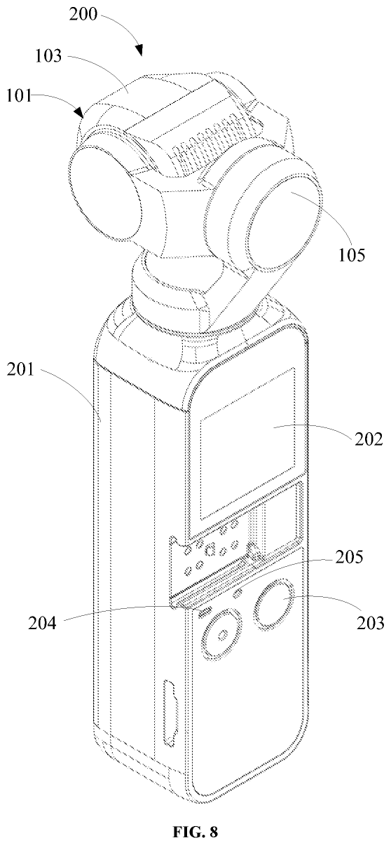

FIG. 8 is 3D schematic diagram of a handheld gimbal 200 according to an embodiment of the present disclosure. The handheld gimbal 200 of this embodiment includes a handle 201, the imaging host 101, and the wireless communication module 102 (as shown in FIG. 1). The imaging host 101 includes a gimbal 105 mounted on the handle 201, a camera 103 disposed on the gimbal 105, and a host interface 104 connected to the camera 103 (as shown in FIG. 1).

The handle 201 can support the gimbal 105, which can be grasped by the user. The handle 201 may include a display screen 202, an operating part 203, a LED display light 204, a microphone 205, etc. The camera 103 and the host interface 104 can be disposed on the gimbal 105. For detailed descriptions of the imaging host 101, the gimbal 105, the wireless communication module 102, etc., reference may be made to the above description, and will not be repeated here.

It should be noted that, in the present disclosure, relational terms such as “first” and “second” are merely used to distinguish one entity or operation from another entity or operation, but do not necessarily require or imply any such actual relationship or order between these entities or operations. The terms “including”, “comprising” or any other similar term are intended to be a non-exclusive inclusion, such that a process, method, article, or device, that comprises a serial of elements, includes not only those elements but also other elements not specifically listed, or elements that are inherent to such a process, method, item, or device. Without additional specification, an element that is defined by the phrase “comprising a . . . ” does not exclude the presence of additional equivalent elements in a process, method, item, or device that includes that element.

The methods and devices provided by the embodiments of the present disclosure are described in detail above. The principles and implementations of the present disclosure are described in the specific examples. The description of the above embodiments is only for helping understand the methods and the key concepts of the present disclosure. Clearly, for those skilled in the art, there will be changes in the specific embodiments and application scopes according to the concepts described in the present disclosure. In summary, the contents of this specification should not be construed as limitations of the present disclosure.

What is claimed is:

1. A handheld gimbal, comprising:
a handle;
an imaging host including a gimbal mounted on the handle, a camera disposed on the gimbal, and a host interface connected with the camera; and
a wireless communication module including a circuit board, a Bluetooth antenna, and a Wi-Fi antenna, the Bluetooth antenna and Wi-Fi antenna being disposed on the circuit board, and the wireless communication module and the host interface being plugged into the imaging host.

2. The handheld gimbal of claim 1, wherein:
the wireless communication module further includes a Bluetooth-Wi-Fi chip, and the Bluetooth-Wi-Fi chip is connected with the Bluetooth antenna and the Wi-Fi antenna.

3. The handheld gimbal of claim 1, wherein:
the wireless communication module further includes a module interface, the module interface is electrically connected with the Bluetooth antenna, and the wireless communication module is placed on the imaging host by connecting the module interface and the host interface.

4. The handheld gimbal of claim 2, wherein:
the Bluetooth antenna and the Wi-Fi antenna are positioned on opposite sides of the Bluetooth-Wi-Fi chip.

5. The handheld gimbal of claim 3, wherein:
the Bluetooth antenna and the Wi-Fi antenna are disposed on a front side of the circuit board, and the module interface is disposed on a back side of the circuit board.

6. The handheld gimbal of claim 1, wherein:
a ground plate is disposed on the circuit board between the Bluetooth antenna and the Wi-Fi antenna.

7. The handheld gimbal of claim 6, wherein:
the ground plate is disposed on a top surface of the circuit board.

8. The handheld gimbal of claim 6, wherein:
the circuit board includes a multilayer circuit board, and the ground plate is disposed on a middle layer of the multilayer circuit board.

9. The handheld gimbal of claim 1, wherein:
the Bluetooth antenna is bent and extended.

10. The handheld gimbal of claim 1, wherein:
the Wi-Fi antenna is bent and extended.

11. The handheld gimbal of claim 1, wherein:
the Bluetooth antenna is configured to receive Wi-Fi passwords.

12. The handheld gimbal of claim 1, wherein:
the Bluetooth antenna is configured to receive a control instruction for controlling the imaging host.

13. The handheld gimbal of claim 12, wherein:
the control instruction includes a gimbal control instruction for controlling a movement of the gimbal and/or an imaging control instruction for controlling the camera.

14. The handheld gimbal of claim 1, wherein:
the Bluetooth antenna is configured to receive an imaging parameter setting signal.

15. The handheld gimbal of claim 1, wherein:
the Wi-Fi antenna is configured to send images and/or videos captured by the camera.

16. The handheld gimbal of claim 1, wherein:
the Wi-Fi antenna is configured to receive a control instruction for controlling the imaging host.

17. The handheld gimbal of claim 16, wherein:
the control instruction includes a gimbal control instruction for controlling a movement of the gimbal and/or an imaging control instruction for controlling the camera.

18. The handheld gimbal of claim 1, wherein:
the Wi-Fi antenna is used to receive an imaging parameter setting signal, and a battery is disposed in the imaging host for powering the imaging host.

19. An imaging system, comprising:
an imaging host including a camera and a host interface connected with the camera; and
a wireless communication module including a circuit board, a Bluetooth antenna, and a Wi-Fi antenna, the Bluetooth antenna and Wi-Fi antenna being disposed on the circuit board, and the wireless communication module and the host interface being plugged into the imaging host.

20. A wireless communication module, comprising:
a circuit board;
a Bluetooth antenna disposed on the circuit board;
a Wi-Fi antenna disposed on the circuit board;
a Bluetooth-Wi-Fi chip disposed on the circuit board, and connected with the Bluetooth antenna and the Wi-Fi antenna; and
a module interface disposed on the circuit board and electrically connected to the Bluetooth-Wi-Fi chip for plugging into an imaging host of an imaging system and connecting the wireless communication module with the imaging host.
